(19) United States
(12) Patent Application Publication
(10) Pub. No.: US 2008/0226226 A1
(43) Pub. Date: Sep. 18, 2008

(54) Simplified Optical Switch

(75) Inventor: Christophe Martinez, Grenoble (FR)

Correspondence Address: OBLON, SPIVAK, MCCLELLAND MAIER & NEUSTADT, P.C., 1940 DUKE STREET, ALEXANDRIA, VA, 22314, US

(73) Assignee: COMMISSARIAT A L'ENERGIE ATOMIQUE, Paris (FR)

(21) Appl. No.: 10/583,857

(22) PCT Filed: Dec. 21, 2004
(86) PCT No.: PCT/FR2004/050739

§ 371 Date: Jun. 21, 2006

(30) Foreign Application Priority Data
Dec. 23, 2003 (FR) 0351188

(51) Int. Cl. G02B 6/35

(52) U.S. Cl. 385/17; 385/18

(57) ABSTRACT

An optical switch to be mounted between first optical lines, each including one or more optical channels having a rank within their optical line, and second optical lines, each including one or more optical channels having a rank within their optical line. The switch includes a selection device with at least one selection element configured to select a single optical channel from a set of at least two optical channels of the first optical lines or the second optical lines, the optical channels of this set having the same rank, and a connection device configured to couple the selected optical channel to one of the channels of the second optical lines or the first optical lines respectively. Such a switch may find application to optical telecommunications.

### TECHNICAL FIELD

The present invention relates to a simplified all-optical switch.

### PRIOR ART

The switching of light beams is developing more and more in telecommunications systems due to the growth in the number of connections to be managed, the number of wavelengths brought into play and the increase in transmission frequencies. All-optical switches are building blocks in architectures currently being developed. This evolution actually makes traditional switching requiring optical electronic conversion increasingly difficult, then after electronic switching, optical electronic conversion. All-optical switches are starting to appear.

The base principle of an all-optical switch, placed between several optical input channels and several optical output channels, is to orient any light beam transmitted by this input channel to any output channel. This is point-to-point switching. In this context, an optical channel is a device capable of transmitting a light beam, and the latter may be guided as in an optical fiber, but transmission may also take place in free space.

An all-optical point-to-point switch is known for example from French patent FR 2 821 681, and is called a router.

In the more complex systems the optical channels are combined into optical lines and the greater the number of channels per line, the more complex and costly the switch becomes. There are however applications which can make do with more limited operating. In these applications, the sole aim is to switch an input line to an output line. This is block-by-block switching. A point-to-point switch is therefore oversized. This is especially the case in the example illustrated in FIG. 1A. Block-by-block switching would be less complex and less cumbersome than point-to-point switching.

FIG. 1A illustrates an example of transmission optical circuit with emergency circuit. It comprises two optical transmission lines A and B, which each comprise n optical channels 1 to 4 (here n=4). The optical line A is a main optical line for conveying optical signals to a user device (not shown) and the optical line B is an optical emergency line for taking the relay of the main optical line A in case of fault D appearing on the latter. A fault can consist of the deterioration of the main optical line A for example by breakage of one or more of its guided optical channels, by cutting of the main optical line A for maintenance works or by the appearance of momentary losses on the main optical line A due to works in the vicinity.

In case of fault D, embodied by two notches on the main optical line A, the optical emergency line B takes the relay for transmission of optical signals by evading fault D. Once the fault is past, the signals conveyed on the optical emergency line B, again transit via the main optical line A. It is important to be able to rapidly switch the main optical line A to the optical emergency line B upstream from the fault D, then the switch from the optical emergency line B to the main optical line A downstream from the fault. There are two 2n×2n (here 8×8) switches available in cascade, one SW1 placed upstream from the fault D and the other SW2 placed downstream from the fault D. Each switch comprises 2n inputs and 2n outputs. The two switches SW1, SW2 are connected at the same time to the line A and to the line B. In FIG. 1A, the arrows show the path followed by the optical signals to be transmitted by the optical circuit. The latter, conveyed by the main optical line A, are diverted towards the optical emergency line B by the first switch SW1 and are diverted from the optical emergency line B to the main optical line A by the second switch SW2.

The switches SW1, SW2 are point-to-point 2n×2n switches and are oversized relative to the usage made of them since, to ensure continuity in transmission, it suffices to switch the main optical line A as a whole with n optical channels to the optical emergency line B with n optical channels. Such switches are very costly, their manufacture and their use are complex and this complexity increases enormously the larger n is. In this application, the use of such switches is unjustified because they are not utilized to the maximum of their possibilities.

With reference to FIG. 1B, this shows a detailed diagram of a conventional 4×4 point-to-point switch, pursuant to the teaching of patent applications FR 2 821 681 and FR 2 821 678, this switch making use of the principle of angular amplification and being reversible.

It comprises in cascade between four first optical channels E1 to E4 and four second optical channels S1 to S4: a first deflection module MDE, a liaison module ML, a second deflection module MDS. This succession of three modules is inserted between a first shaping module Ble1 and a second shaping module Ble2.

The first and second shaping modules Ble1 and Ble2 comprise shaping elements (here four in number) arranged as a small rod. The first deflection module MDE comprises a first and a second group BF1, BF2 of several deflection elements F1, F2, (here each four in number) for example each arranged as a small rod, separated by a set Ba1 of several optical conjugation elements a1 (four in number) arranged for example as a small rod. The second deflection module MDS comprises a first and a second group BF1′, BF2′ of deflection elements F1′, F2′ (each four in number) for example arranged as a small rod, separated by a set Ba1′ of optical conjugation elements a1′ (four in number) arranged for example as a small rod. The number of four for the different elements corresponds to the number of inputs and the number of outputs of the point-to-point switch.

By small rod of optical elements (deflection elements (mirrors), deviation elements (lenses), shaping elements (lenses) . . . ), is meant the possibility of manufacturing the optical elements collectively and utilizing them grouped, so as to simplify their positioning. By way of example a small rod of lenses currently used in a switch such as that in the patent applications cited hereinabove corresponds to a block of silica measuring 5 mm×3 mm×2.5 mm, on which polymer lenses have been deposited, the diameter of which is 600 micrometers.

The role of the shaping elements le1, le2 is to shape the light beams (not shown) originating from the optical channels E1 to E4 and to the optical channels S1 to S4, by making an optical conjugation between the origin of the light beams originating from the optical channels E1 to E4 (respectively S1 to S4) and the deflection elements F1 (respectively F2′). To ensure this optical conjugation, lenses or micro-lenses can be used, for example.

The deflection elements F1, F2, F1′, F2′ can be mirrors (micro-mirrors) orientable about an axis, suitable for assuming at least two angular positions.

The conjugation elements a1, a1′ achieve the desired object-image conjugation between the successive deflection elements F1, F2 and F1′, F2′ with appropriate magnification. These conjugation elements a1, a1′ can be lenses or micro-lenses, for example.

The linking module ML creates a one-to-one conjugation between the different positions of angular deflection generated by the first deflection module MDE and the deflection elements F1′ of the first group BF1′ of the second deflection module MDS. Such a linking module ML can be created for example by an appropriate lens, for example as described in the patent applications FR 2 821 681 or FR 2 821 678.

This configuration is complex to achieve and utilize, in view of the large number of deflection elements coming into play. For four input channels, there are four small rods BF1, BF2, BF1′, BF2′ of four deflection elements F1, F2, F1′, F2′ or sixteen deflection elements.

### DISCUSSION OF THE INVENTION

The aim of the present invention is to propose an optical switch which does not have the disadvantages mentioned hereinabove, especially the complexity of production and utilization, as well as cost.

An aim of the invention is to propose a simplified optical switch which is capable of commuting as a whole the optical channels of at least one first optical line to the optical channels of a second optical line, this switching retaining or not the rank they had in the first optical line, by optical channels, in the second optical line.

To achieve this, the present invention proposes introducing to the switch at least one function for selecting between light beams of different lines having the same rank.

More precisely, the present invention is an optical switch intended to be mounted between first optical lines each comprising one or more optical channels having a rank within their optical line and one or more second optical lines each comprising one or more optical channels having a rank within their optical line. The switch comprises:

selection means comprising at least one selection element suitable for selecting a single optical channel from among a set of at least two optical channels of the first optical lines or the second optical lines, the optical channels of this ensemble having the same rank, the selection element comprising at least one deviation element such as a lens associated with at least one deflection element such as a mirror suitable for assuming several angular positions,

connection means suitable for coupling the selected optical channel to one of the channels of the second optical lines or the first optical lines respectively.

Such a switch is reversible, and functions in two directions from the first optical lines to the second optical lines and/or vice-versa.

Among these angular positions, one of the positions is a rest position located between two active positions.

When the deviation element is a lens, the optical channels of the whole can be placed such that the light beams originating from said optical channels take their origin at the focal point, the object of the deviation lens, the deflection element being placed at the focal point image of the deviation lens.

For ease of assembly, the selection elements can be combined into one or more selection modules.

Each selection module can comprise N selection elements connected in parallel, the deviation elements just the same as the deflection elements of these N selection elements being arranged as small rods of N elements.

The connection means can thus be located after a selection module or else between two selection modules.

The connection means can comprise at least one optical connection in free or guided space. The connection in free space can comprise at least one small rod of lenses.

In one alternative, the connection means can comprise a liaison module.

In certain applications in which the rank of the channels of a line is changed after undergoing switching, the connection means can encompass point-to-point switching means. The latter will be less complex and less costly than those used in the past, as they will not act on all the channels, but just on those selected.

The point-to-point switching means can comprise a cascade with a first deflection module, a linking module, and a second deflection module.

The first and second deflection modules can be made from small rods similar to those used to make up the selection modules.

The cascade can be inserted between a first shaping module and a second shaping module.

The first and second shaping modules can be made from small rods similar to the small rods of deviation elements used to produce the selection modules.

In these point-to-point switching means, a deflection module can comprise one or more conjugation elements between one or more first deflection elements and one or more second deflection elements.

The conjugation elements of a deflection module can be arranged in the small rod similar to a small rod of deviation elements used for a selection module.

The first and second deflection elements can be arranged as a small rod similar to the small rods of deflection elements of the selection modules.

To further simplify the switch, one or more deflection elements from at least one deflection module of the point-to-point switching means are combined with one or more deflection elements of the selection means.

The switch can have 2N input channels and N output channels, the selection means comprise a selection module made up of N selection elements mounted in parallel, the connection means comprise a point-to-point switch (MCP) N×N, the selection module and the point-to-point switch being made from small rods of N lenses and small rods of N mirrors suitable for assuming at least two angular positions.

The optical switch can have 2N input channels and 2N output channels, the selection means are then formed by an input selection module, an output selection module and the switching means of a point-to-point switch N×N located between the input selection module and the output selection module, the selection modules being made up of N selection elements mounted in parallel, these selection modules and the point-to-point switch being made from small rods of N lenses and small rods of N mirrors suitable for assuming at least two angular positions.

The present invention likewise relates to an optical switch having 2N input channels and N output channels. It can comprise selection means formed by a selection module made up of N selection elements mounted in parallel, connection means formed by a point-to-point switch N×N, the selection module and the point-to-point switch being made from small rods of N lenses and small rods of N mirrors suitable for assuming at least two angular positions.

### BRIEF DESCRIPTION OF THE DRAWINGS

The present invention will be better understood from the description of given embodiments, purely indicative and in no way limiting, with reference to the appended drawings wherein:

FIGS. 1A and 1B (already described) are an example of an optical transmission circuit with an emergency circuit using conventional point-to-point switches and a detailed diagram of one of the conventional point-to-point switches;

FIGS. 2A to 2C show a first embodiment of a selection element and the potential positions assumed by its deflection element;

FIGS. 3A to 3C show a second embodiment of a selection element;

FIGS. 4A, 4B, 4C respectively show a flow chart of a switch according to the invention suitable for replacing one of the switches SW1, SW2 of FIG. 1A, and two embodiments of such a switch;

FIG. 5A is an example of an optical circuit with main line and emergency line and two conventional point-to-point switches for switching the channels from the main line to the channels of the emergency line, with the rank of the optical channels not being forcibly retained during switching;

FIGS. 5B, 5C, 5D respectively show a flow chart of a switch according to the invention suitable for replacing one of the switches of FIG. 5A and two detailed embodiments of the switch of FIG. 5B;

FIG. 6A is an example of an optical circuit with two conventional point-to-point switches for switching the channels from one optical line to the channels of another optical line, the rank of the optical channels not being forcibly retained during switching;

FIGS. 6B, 6C, 6D respectively show a flow chart of a switch according to the invention suitable for replacing one of the switches of FIG. 6A and two detailed embodiments of the switch of FIG. 6B.

Identical, similar or equivalent parts of the different figures described hereinafter bear the same reference numerals so as to facilitate passing from one figure to the other.

These different possibilities (alternatives) must be understood as not being forcibly exclusive from one another.

### DETAILED DESCRIPTION OF PARTICULAR EMBODIMENTS

Reference is now made to FIG. 2A which shows a selection element Sel of a switch according to the invention. The selection element Sel illustrated is capable of selecting a channel 1b selected from among several optical channels 1a, 1b. Each of these optical channels 1a, 1b is intended to convey a light beam respectively φ1a, φ1b. The selection element Sel transmits the light beam φ1b originating from the selected optical channel 1b to a user device Du.

The selection element Sel comprises a deviation element such as a deviation lens 2a (advantageously a micro-lens) which cooperates with a deflection element 3a suitable for assuming at least two angular deflection positions, by rotation about an axis Z′, these angular positions being separated by Δθ. The deflection element 3a can advantageously be a mirror or a micro-mirror produced by microtechnology techniques. The two optical channels 1a, 1b are placed such that the origin of the light beams φ1a, φ1b originating from the optical channels 1a, 1b is at the focal point object of the deviation lens 2a. The deflection element 3a is located at the focal point image of the deviation lens 2a. The light beams φ1a, φ1b originating from the optical channels 1a, 1b are eccentric relative to the optical axis X′ of the deviation lens 2a. This axis X′ is shown in dotted lines. After passing through the same deviation lens 2a, the light beams φ1a, φ1b present angular deviation δa relative to the optical axis X′, and converge at the same point of the deflection element 3a. The optical channels can be optical fibers, free space or even optical sources, for example laser diodes.

For small angles δa, the following can be written:

δa=d/F₂ₐ with d distance separating the centres of the optical channels 1a, 1b and F₂ₐ the focus of the deviation lens 2a.

If δa is selected, according to the angular position of the deflection element 3a, a single light beam φ1b originating from one of the optical channels 1a, 1b will be directed, after deflection on the deflection element 3a, according to the optical axis X′ of the selection element Sel and it will be able to reach the user device Du. The optical axis X′ of the selection element 3a corresponds on one side to the optical axis of the deviation lens 2a and on the other side to the same optical axis having been deflected by the deflection element 3a in the rest position between the two angular positions. In this example, as it leaves the deviation lens 2a the optical axis X′ describes an angle of 45° with the deflection element 3a. The other light beam φ1a which is not selected will be strongly deviated and will not be able to reach the user device Du. By changing the inclination of the deflection element 3a, the inverse is created, and it is the other light beam φ1a which is selected. The inclination of the deflection element 3a thus enables one light beam to be selected rather than another and thus allows one optical channel to be selected rather than another.

When the two light beams φ1a, φ1b form a plane (hatched in FIG. 2B) which is perpendicular to the axis of rotation of the deflection element 3a, the result is δa=2Δθ. This configuration is illustrated in FIG. 2B.

When the light beam which is selected φ1a or φ1b and the perpendicular to the deflection element 3a form a plane (hatching in FIG. 2C) which contains the axis of rotation Z′ of the deflection element 3a, this gives δa=KΔθ with K=2^{1/2} in the case of incidence ψ of the light beams φ1a, φ1b equal to 45°. This configuration is illustrated in FIG. 2C.

The light beams φ1a, φ1b originating from the optical channels 1a, 1b can be assimilated to Gaussian beams. These Gaussian beams have the property of remaining Gaussian throughout a succession of optical conjugations. Their minimum beam currently called <<waist >> determines the characteristics of the light beam and in particular its divergence.

At the level of the deflection element 3a, there is a conjugation of the <waists >> of the beams originating from the optical channels.

It is possible to use a deflection element 3a suitable for assuming an additional angular position. In addition to the two angular positions mentioned hereinabove, a rest position located in the middle between the two aforementioned positions is used. This rest position to be used effectively must be sufficiently stable.

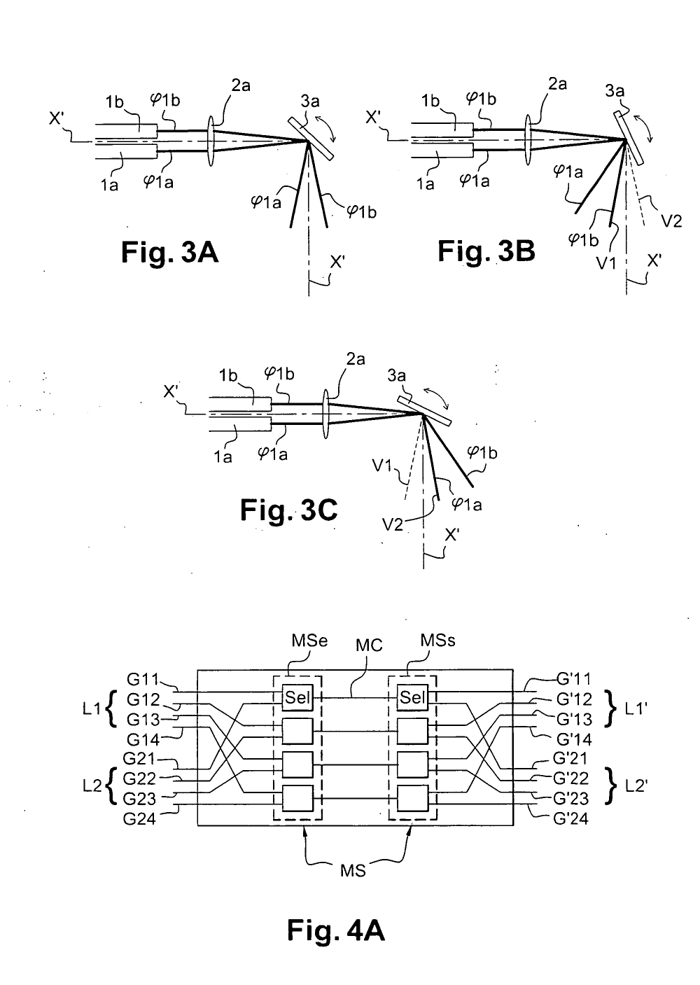

In this case, the selection element likewise ensures a deflection function. In FIG. 3a, the deflection element 3a is in the rest position, and is oriented at 45° relative to the optical axis X′ of the deviation lens 2a. The light beams φ1a, φ1b originating from the optical channels 1a, 1b after having passed through the same deviation lens 2a converges on the same point of the deflection element 3a and depart in diverging, symmetrical directions V1, V2 relative to the optical axis X′. By placing the utilization device (not shown) in one of the directions rather than in the other, one of the light beams (φ1a or φ1b is selected.

It is easily shown that with proper agreement between δa and Δθ (for example δa=Δθ in the case of FIG. 2C), if the inclination of the deflection element 3a is modified by having it assume one of the active or positive positions (FIG. 3B) the light beam φ1b can be switched from the direction V2 to the direction V1, and by having it assume the other active or negative position (FIG. 3C) the light beam φ1a is switched from the direction V1 to the direction V2.

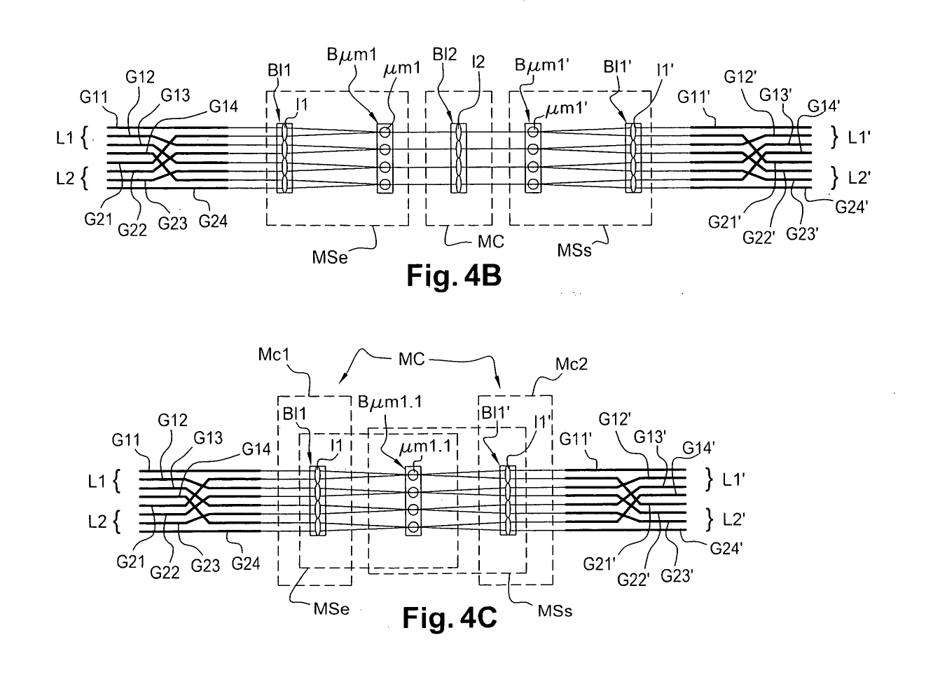

After having explained the functioning of such a selection element, a switch according to the invention can now be described, with reference to FIGS. 4A, 4B.

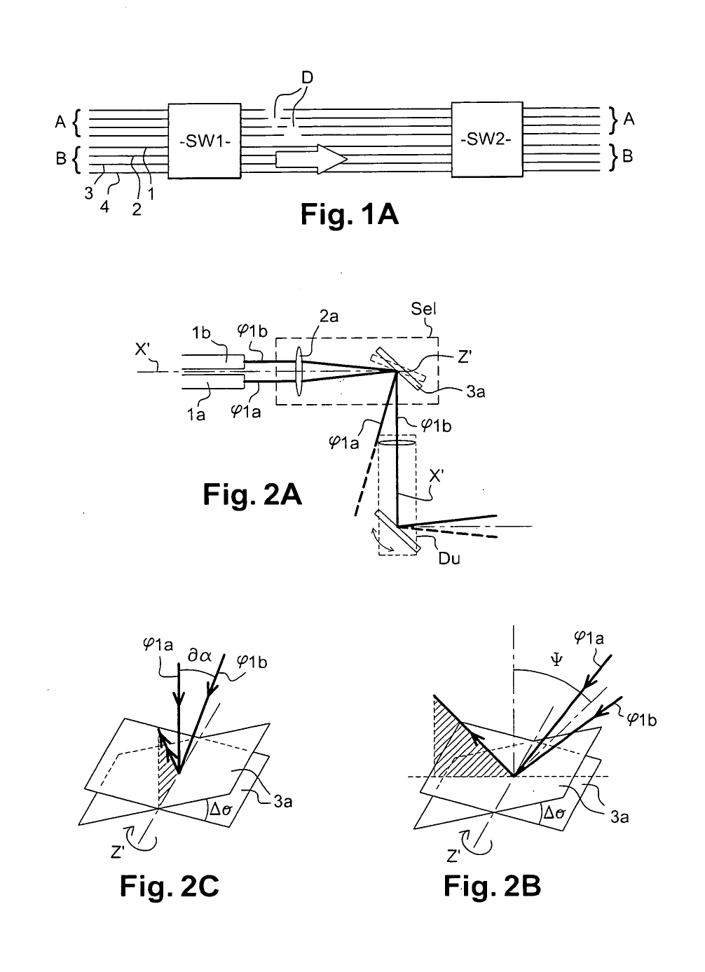

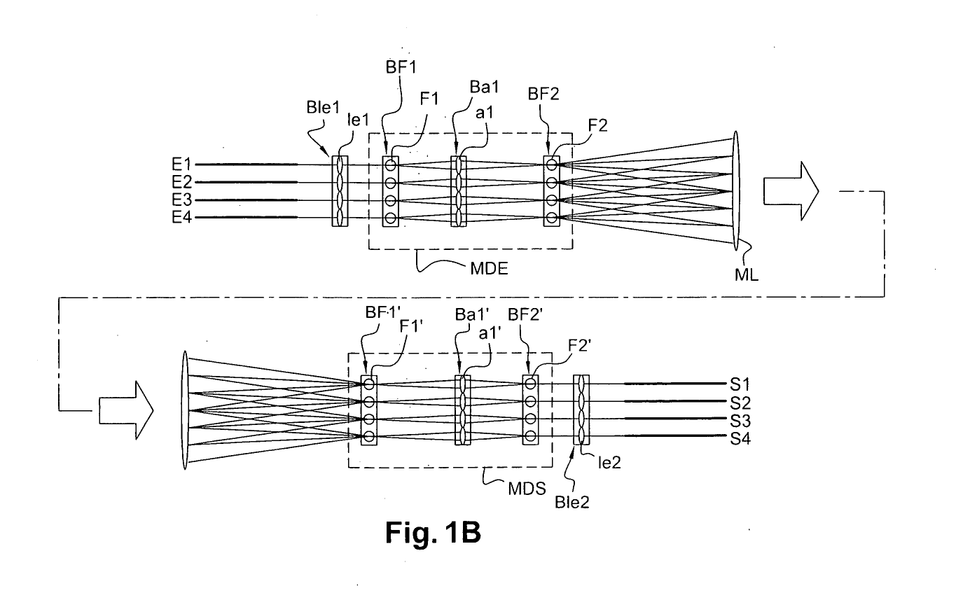

FIG. 4A shows a flow chart of a switch according to the invention, capable of commuting as a whole the channels of the optical line A on the optical line B and therefore suitable for replacing the switch SW1 of FIG. 1A. This is a switch with 8 inputs and 8 outputs. It could likewise replace the switch SW2 of FIG. 1A based on its reversibility.

The switch is mounted between P first optical lines L1 and L2 (here P=2) and Q second optical lines L1′ and L2′ (here Q=2). The first optical lines L1 and L2 each combine R (here R=4) optical channels designated G11 to G14 for the line L1 and G21 to G24 for the line L2. R represents the rank which an optical channel has within its optical line. The second optical lines L1′ and L2′ each combine S (here S=4) optical channels designated G11′ to G14′ for the line L1′ and G21′ to G24′ for the line L2′. S represents the rank which an optical channel has within its optical line. In the example, the first lines are input lines and the second lines are output lines. The inverse would be possible, since the switch is fully reversible.

The switch object of the invention comprises selection means MS of at least one optical channel, formed by one or more selection elements Sel. Each selection element Sel can be similar to that of FIG. 2a. Each of the selection elements Sel is coupled to several optical channels (for example G11 and G21 for the selection element designated Sel left or G11′ or G21′ for the selection element designated Sel right). These optical channels belong to optical lines L1, L2 or L1′, L2′ different, but do not have the same rank within their respective line. The rank is embodied here by their second index and is 1 in the present example. Each of the selection elements Sel selects one only of the optical channels to which it is coupled.

In the example of FIG. 4A, the selection means MS are classified into a first selection module MSe with one or more selection elements and a second selection module MSs with one or more selection elements. In the example, the first selection module MSe is considered as an input module and the second selection module MSs is considered as an output module.

The switch object of the invention likewise comprises connection means MC suitable for connecting the selected optical channel for example G1 or G11′ to one of the channels of the Q second optical lines L1′ or L2′ or P first optical lines L1, L2 respectively. The connection means MC are inserted between the two selection modules MSe, MSs.

The connection means MC can be formed by one or more simple optical connections in free space. It suffices to place in congruence two by two the selection elements Sel of the first selection module MSe with the selection elements Sel of the second selection module MSs. As an alternative, the connection means MC can be formed by one or more optical connections in guided space and be formed for example from optical fibers joining the outputs of the first selection module MSe to the inputs of the second selection module MSs.

With such a switch qualified as hybrid, since it fulfils the selection functions, the optical channels G1 to G14 of the first line L1 can be coupled as a whole to the optical channels G21′ to G24′ of the second optical line L2′ after double selection. Such a switch is much simpler to make than the 8×8 conventional switch SW1 of FIG. 1B.

Reference is now made to FIG. 4B which illustrates in detail a switch according to the invention, similar to that of FIG. 4A.

In this example, the first selection module MSe comprises one or more deviation elements l1 associated with one or more deflection elements μm1 configured as per FIG. 2A. The deflection elements μm1 are suitable for assuming two angular positions. The deviation elements l1 and the deflection elements μm1, four in number in this example, are arranged advantageously as small rods designated respectively Bl1 and Bμm1. In similar fashion, the second selection module MSs comprises one or more deviation elements l1′ arranged in the small rod Bl1′ associated with one or more deflection elements μm1′ arranged in the small rod Bμm1′. The connection means MC are formed by one or more lenses l2 (in the example four) arranged as a small rod Bl2. The lenses l2 of the connection means MC can be shaping lenses which serve to conjugate the different light beams passing through it and ensuring their parallelism. Each of these shaping lenses l2 images the <<waist >> of the light beam transmitted by the selected channel on the deflection element μm1 of the first deflection module Bμm1 to that present on the deflection element μm1′ corresponding to the second deflection module Bμm1′.

By astutely choosing the angular position of the deflection elements μm1 and μm1′ of the deflection modules Bμm1 and Bμm1′, it is possible to switch as a whole, without changing their rank, the channels G11 to G14 or G21 to G24 from the first lines L1 or L2 to those G11′ to G14′ or G21 to G24′ of one of the second lines L1′ or L2′ and vice versa. Such a hybrid 8×8 switch is extremely simple and compact, comprising only two small rods of four deflection elements. As a matter of interest, in a conventional 8×8 switch, based on the diagram of the switch of FIG. 1B, it would be necessary to make use of 6 small rods of deflection elements and lenses with 8 elements. The present switch makes use of only 2 small rods with 4 elements.

FIG. 4C illustrates a switch according to the invention derived from that shown in FIG. 4B; it is more compact and comprises fewer components than that of FIG. 4B. The switch still comprises selection means MS sorted into a first selection module MSe and a second selection module MSs in cascade, these selection means cooperating with connection means MC. The first selection module MSe is embodied by deviation elements l1 (for example lenses or micro-lenses) arranged in the small rod Bl1 and deflection elements μm1.1 arranged in the small rod Bμm1.1. The second selection module MSs is embodied by deviation elements l1′ (for example lenses or micro-lenses) arranged in the small rod Bl1′ and deflection elements μm1.1 arranged in the small rod Bμm1.1. In this simplified example, the deflection elements μm1.1 are common to the first selection module MSe and to the second selection module MSs. In this exemplary embodiment, the deflection elements μm1.1 will be suitable for assuming several angular position, including a middle rest position. Each deflection element can be similar to that illustrated in FIGS. 3A to 3C.

The connection means MC are classified into first connection means Mc1 embodied by the deviation elements l1 and second connection means Mc2 embodied by the deviation elements l1′.

It is understood that when the deflection elements μm1.1 are idle, the following functioning results: the signals conveyed by the channels G1 to G14 of the line L1 are oriented to the channels G21′ to G24′ of the line L2′ and the signals conveyed by the channels G21 to G24 of the line L2 are oriented as a whole to the channels G11′ to G14′ of the line L1′. The switchings are simultaneous between the lines L1-L2′ and L2-L1′.

When the deflection elements μm1.1 can likewise assume an active positive position, the signals conveyed by the channels G1 to G14 of the line L1 are oriented as a whole to the channels G11′ to G14′ of the line L1′. Optional signals conveyed by the channels G21 to G24 of the line L2 are lost. The deflection elements μm1.1 can likewise assume an active negative position, the signals conveyed by the channels G21 to G24 of the line L2 are then oriented to the channels G21′ to G24′ of the line L2′. Optional signals conveyed by the channels G11 to G14 of the line L1 are lost.

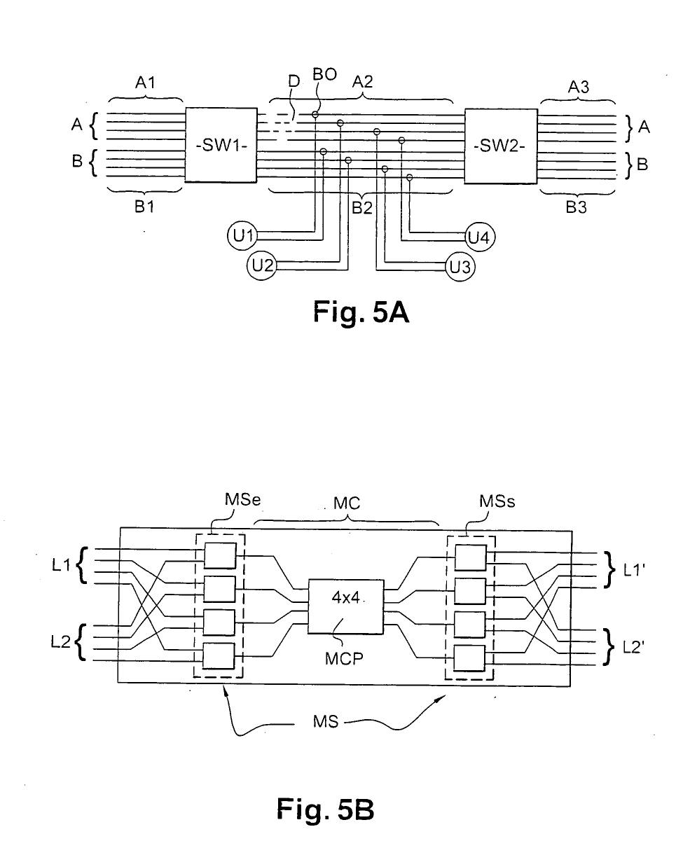

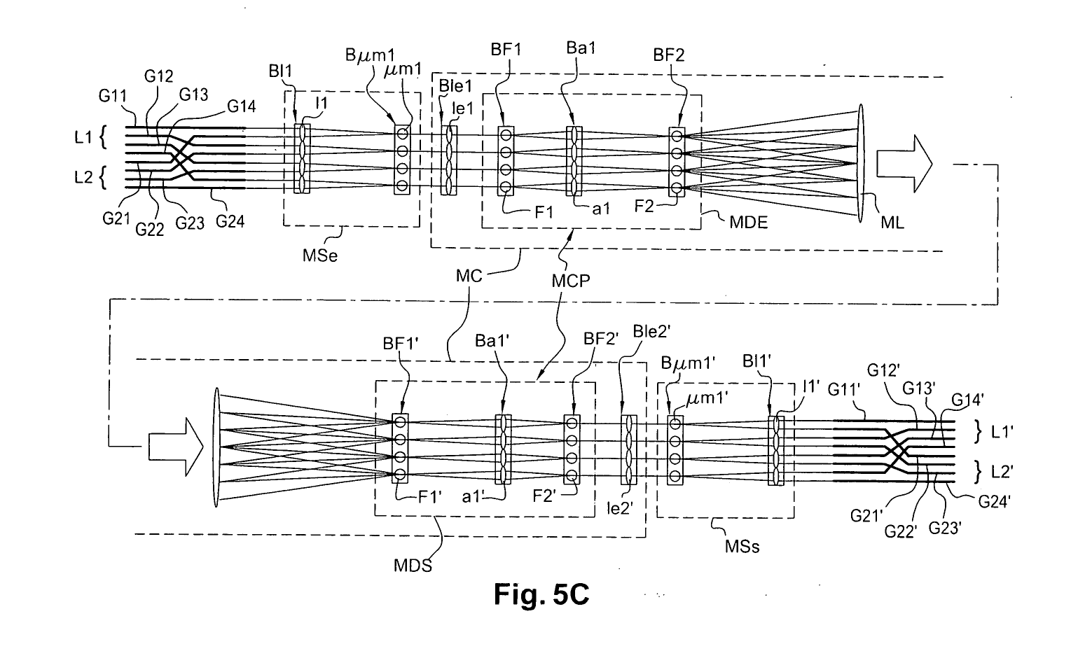

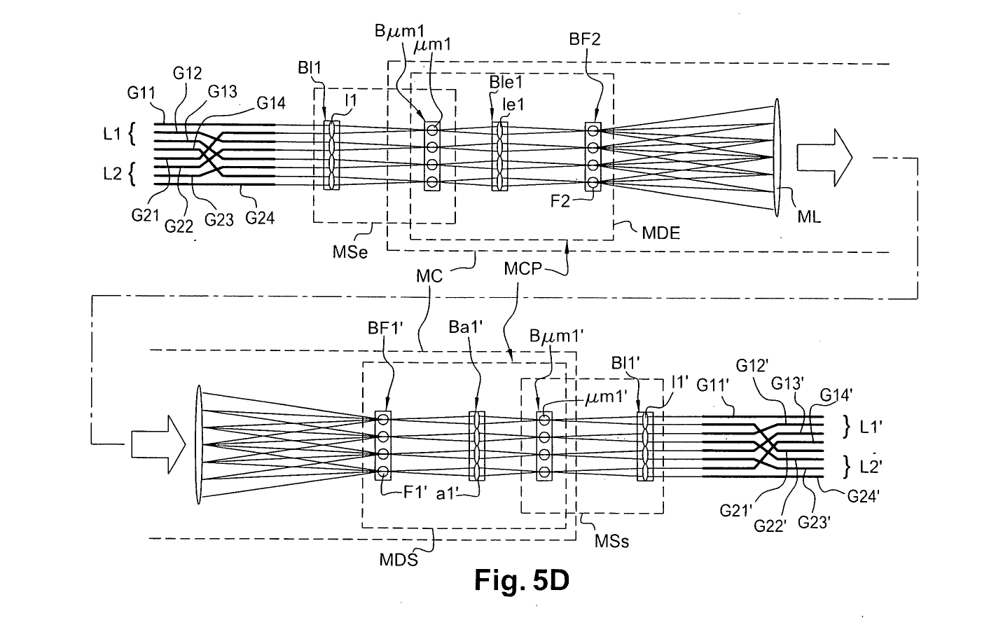

A second example of application, illustrated in FIG. 5A, in which an optical transmission circuit comprises underused switches SW1, SW2 of the prior art, will now be analysed. As per FIG. 1A, two optical lines A, B are shown, each having four optical channels 1 to 4. These optical lines A, B are distributed over several sections A1, A2, A3 and B1, B2, B3. Among these sections are a first end section A1, B1, an intermediate section A2, B2 and a second end section A3, B3. The optical lines A, B cooperate with a first switch 8×8 SW1 as well as with a second switch 8×8 SW2 in cascade. The optical line B is an emergency line, and doubles the optical line A which is known as the principal line.

The first switch SW1 is mounted between the first end section A1 (respectively B1) and the intermediate section A2 (respectively B2) of the line A (respectively B). The second switch SW2 is mounted between the intermediate section A2 (respectively B2) and the second end section A3 (respectively B3) of the line A (respectively B).

Four users U1 to U4 are each connected, by appropriate insertion/extraction terminals BO, to a channel of the main optical line A and of the optical emergency line B at the intermediate sections A2, B2. In case of fault D on the main line A, the signals conveyed by the line A bypass it due to the switch SW1 via the channel emergency B, before returning due to the switch SW2 on the main channel A, once the fault D is bypassed.

The difference with the case illustrated in FIG. 1A is that between the two switches SW1, SW2, the channels 1 to 4 of the intermediate sections A2, B2 of the main line A and of the protection line B are not equivalent because of the different processing operations which can be introduced on channels 1 to 4 by the different users U1 to U4.

The switch SW1 must therefore be capable of coupling any one of the channels of the first end section A1 to any one of the channels of the intermediate section A2 of the same optical line A, or to any one of the channels of the intermediate section B2 of the optical line de protection B. This functionality is achieved by the point-to-point switch SW1 employed below its capacities. In effect, only four inputs and four outputs are utilized continuously. The same applies for the switch SW2 which is likewise underused.

FIG. 5B illustrates a flow chart of a switch according to the invention capable of being substituted for the switch SW1 described in FIG. 5A. It would also be suitable to replace the switch SW2 since it is reversible.

As in the first embodiment of FIG. 4A, the switch comprises selection means MS and connection means MC, the latter now including point-to-point switching means MCP. A before, the switch is placed between, on one side two first optical lines L1, L2, and on the other side two second optical lines L1′, L2′. The selection means are similar to those of FIG. 4A with in cascade a first selection module MSe and a second selection module MSs. The point-to-point switching means MCP are inserted between the two selection modules MSe, MSs.

More generally, a 2N×2N switch is created with the point-to-point switching means MCP which are a point-to-point switch of N×N type and selection means formed by a first selection module MSe with N selection elements in parallel and a second selection module MSs with N selection elements in parallel. The selection modules and the point-to-point switch are made from small rods of N lenses and from small rods of N mirrors suitable for assuming at least two angular positions. Making a 2N×2N switch according to the teaching of patent application FR 2 821 678 would require having small rods of 2N mirrors and small rods of 2N lenses. The structure has been greatly simplified by reducing the number of optical elements with a constant number of channels or the number of channels with a constant number of optical elements has been doubled. Because of this, this FIG. 5B illustrates a version of 2N×2N switching whereof the functionality is intermediary between the switches N×N and 2N×2N according to the teaching of the patent application FR 2 821 678.

Reference will now be made to FIG. 5C which illustrates in detail the structure of such a switch according to the invention. The first selection module MSe comprises one or more selection elements formed by deviation elements l1, (lenses, four in number in the example), arranged in the small rod Bl1 cooperating with one or more deflection elements μm1 (mirrors, four in number) arranged in the small rod Bμm1. The second selection module MSs comprises one or more selection elements formed by deviation elements l1′ (here lenses four in number) arranged in the small rod Bl1′ cooperating with one or more deflection elements μm1′ (mirrors four in number) arranged in the small rod Bμm1′. The first selection module MSe is coupled to the lines L1, L2. The second selection module MSs is coupled to the lines L1′, L2′.

Located between these two selection modules MSe and MSs in cascade are connection means MC including conventional point-to-point switching means MCP (in the example 4×4) similar to those shown in FIG. 1B. The different components forming these point-to-point connection means MCP are designated as in FIG. 1B, i.e. a first deflection module MDE, a liaison module ML, a second deflection module MDS. This succession of deflection and liaison modules can be placed between a first shaping module Ble1 and a second shaping module Ble2.

The first deflection module MDE comprises a first and a second group BF1, BF2 of several deflection elements F1, F2, (four in number) for example arranged as a small rod, separated by a set Ba1 of several optical conjugation elements a1 (four in number) arranged for example as a small rod. The second deflection module comprises a first and a second group BF1′, BF2′ of several deflection elements F1′, F2′ (four in number) for example arranged as a small rod, separated by a set Ba1′ of several optical conjugation elements a1′ (four in number) arranged for example as a small rod. The first and second shaping modules Ble1 and Ble2 comprise several shaping elements le1, le2 (four in number) which can be lenses (micro-lenses) arranged as a small rod. These shaping elements likewise serve as conjugation elements of the image object.

FIG. 5D illustrates, as per FIG. 4C, a switch of the same type as that of FIG. 5C, but simpler and more compact, with fewer components. As in FIG. 5C, in cascade between the optical lines L1, L2 on the one hand and the optical lines L1′, L2′ on the other hand, there is a first selection module MSe, connection means with conventional switching means MCP formed by a first deflection module MDE, by a linking module ML, a second deflection module MDS and finally a second selection module MSs. Relative to the configuration of FIG. 5C, the first and second shaping modules are omitted in the point-to-point switching means MCP. This will become evident hereinbelow. Another difference with FIG. 5C is that the deflection elements F1 of the first group BF1 of deflection elements of the first deflection module MDE are combined with the deflection elements μm1 of the first selection module MSe, thus the first shaping module Ble1 is superfluous. Similarly, the deflection elements F2′ of the second group BF2′ of deflection elements of the second deflection module MDS are combined with the deflection elements μm1′ of the second selection module MSs. The second shaping module Ble2 is superfluous. The deflection elements μm1 and μm1′ utilize the middle position as those shown in FIGS. 3A to 3C.

The advantage to this configuration is to use few deflection elements, however, its functioning is less efficient than the configuration of FIG. 5C. In certain cases this is enough. However, the limited number of deflection elements can induce light beams to pass unwanted between non-utilized optical channels. If the switch is utilized by coupling the line L1 to the line L2′, it is possible simultaneously, for certain angular positions of deflection elements, for a light beam conveyed by one optical channel of the optical line L2 to be directed to an optical channel of the optical line L1′. These two optical lines are generally not utilized at the moment, and should not pose a problem.

Reference will now be made to another example of a switching circuit in which a switch of the invention is particularly advantageous.

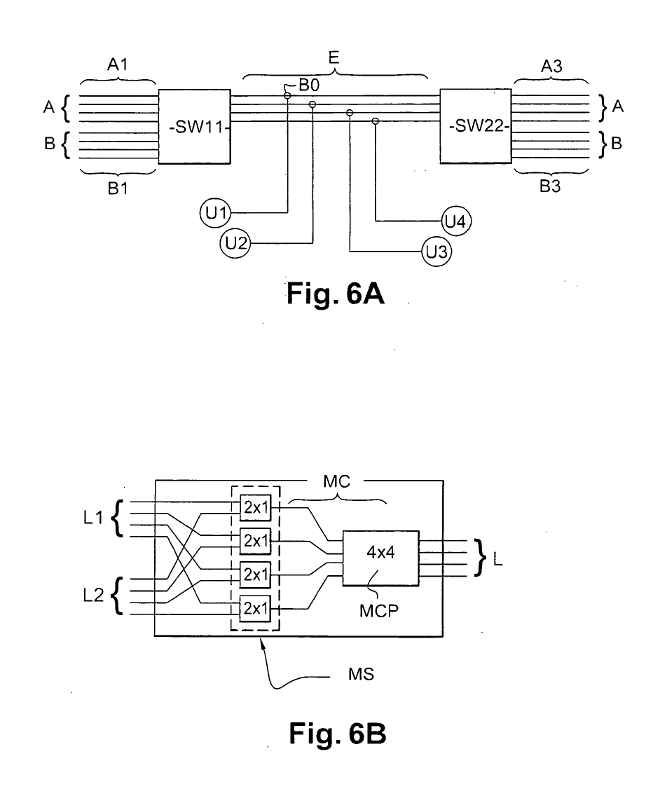

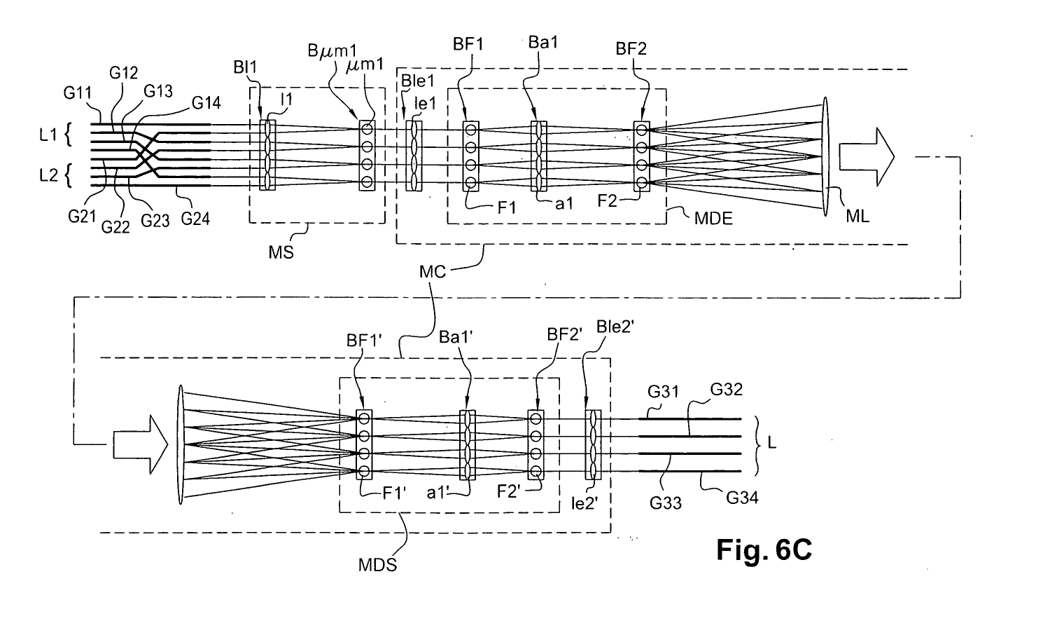

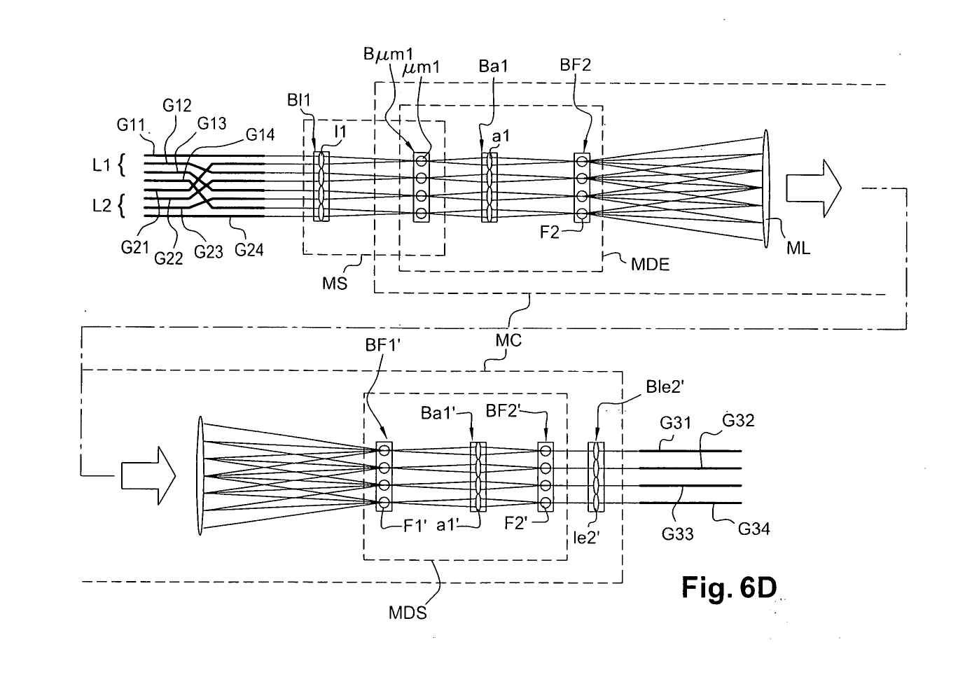

FIG. 6A shows an optical transmission circuit which has a 8×4 switch SW11 and a 4×8 point-to-point switch SW22, these conventional switches being underused.

This optical circuit has two optical lines A, B, each having four optical channels 1 to 4. These lines each comprise two end sections A1, A3 and B1, B3. The first end sections A1, B1 are connected to the first switch SW11 (at its input). The second end sections A3, B3 are connected to the second switch SW22 at its output. The two switches SW11, SW22 are connected to one another by an auxiliary optical line E having four optical channels (not designated). It connects the output of the first switch to the input of the second switch. Four users U1 to U4 are each connected, by appropriate insertion/extraction terminals BO, to a channel of the auxiliary line E.

In this circuit, point-to-point switching should be possible between one of the first end sections A1, B1 and one of the second end sections A2, B2 because of the presence of the insertion/extraction terminals BO. But however, the presence of two point-to-point switches such as SW11 or SW22 is unnecessary.

Reference is made to FIG. 6B which shows a diagram of a switch according to the invention which can be substituted for the switch SW11. It could likewise replace the switch SW22 since it is reversible.

It comprises in cascade selection means with a single selection module MS and connection means MC including point-to-point switching means MCP. The selection means MS are coupled to two optical lines L1, L2 and to the connection means MC. The connection means are coupled to an auxiliary line L. The optical lines L1, L2 each comprise four optical channels designated G1 to G14 and G21 to G24 respectively (visible in FIG. 6C). The auxiliary optical line L comprises four optical channels G31 to G34 (visible in FIG. 6C).

More generally, a switch 2N-×N is created with the point-to-point switching means MCP which are a point-to-point switch of type N×N and selection means formed by a selection module MS with N selection elements in parallel. The selection module and the point-to-point switch are made from small rods of N lenses and small rods of N mirrors suitable for assuming at least two angular positions. The same remarks as those explained above in the description of FIG. 5B apply here.

Reference will now be made to FIG. 6C which illustrates in detail the structure of such a switch according to the invention.

The selection means MS comprise a single selection module MS coupled to the lines L1, L2. This selection module is similar to that MSe of FIG. 5C with lines L1, L2, one or more deviation elements l1 (made for example by lenses), four in number, arranged in the small rod Bl1 followed by one or more deflection elements μm1 (made for example by mirrors), four in number, arranged in the small rod Bμm1. The connection means MC including the point-to-point switching means MCP are similar to those of FIG. 1B with, in cascade, a deflection input module MDE, a liaison module ML, a deflection output module MDS. These switching means can be placed between a first and a second shaping module Ble1, Ble2.

Reference will now be made to FIG. 6D which shows a switch according to the invention based on the same principle as that of FIG. 6C, but simplified, more compact and less costly, since it uses fewer components. As before, the deflection elements F1 of the first group BF1 of deflection elements of the first deflection module MDE are combined with the deflection elements μm1 of the selection module MS. The shaping elements le1 of the first shaping module Ble1 were superfluous, and were replaced functionally with the deviation lenses l1 of the selection module MS. The deflection elements μm1 utilize the middle position as those shown in FIGS. 3A to 3C.

Even though several embodiments of the present invention were shown and described in detail, it is understood that different changes and modifications could be made without departing from the scope of the invention.

1-24. (canceled)

25. An optical switch configured to be mounted between first optical lines, each including one or more optical channels having a rank within their optical line, and one or more second optical lines, each including one or more optical channels having a rank within their optical line, the optical switch comprising:
selection means including at least one selection element configured to select a single optical channel from among a set of at least two optical channels of the first optical lines or second optical lines, the optical channels of the set having the same rank, the selection element including at least one deviation element associated with at least one deflection element configured to assume plural angular positions; and
connection means for coupling the selected optical channel to one of the channels of the second optical lines or of the first optical lines respectively.

26. The optical switch as claimed in claim 25, wherein it is reversible.

27. The optical switch as claimed in claim 25, wherein one of the angular positions is a rest position located between two active positions.

28. The optical switch as claimed in claim 25, wherein each of the optical channels is configured to convey a light beam, wherein the deviation element is a deviation lens, and the optical channels of the set are configured such that light beams originating from the optical channels take their origin at a focal point object of the deviation lens, the deflection element being placed at the focal point image of the deviation lens.

29. The optical switch as claimed in claim 25, wherein each of the at least one selection element is combined into one or more selection modules.

30. The optical switch as claimed in claim 29, wherein each selection module includes N selection elements connected in parallel, the deviation elements and the deflection elements of the N selection elements being arranged as small rods of N elements.

31. The optical switch as claimed in claim 29, wherein the connection means is located between two selection modules.

32. The optical switch as claimed in claim 29, wherein the connection means is located after a selection module.

33. The optical switch as claimed in claim 25, wherein the connection means includes at least one optical connection in free or guided space.

34. The optical switch as claimed in claim 33, wherein the optical connection in free or guided space comprises at least one small rod of lenses.

35. The optical switch as claimed in claim 25, wherein the connection means includes a liaison module.

36. The optical switch as claimed in claim 25, wherein the connection includes point-to-point switching elements.

37. The optical switch as claimed in claim 36, wherein the point-to-point switching elements include a cascade with a first deflection module, a liaison module, and a second deflection module.

38. The optical switch as claimed in claim 37, wherein the first and second deflection modules include small rods.

39. The optical switch as claimed in claim 37, wherein the cascade is inserted between a first shaping module and a second shaping module.

40. The optical switch as claimed in claim 39, wherein the first and second shaping modules include small rods.

41. The optical switch as claimed in claim 37, wherein a deflection module of the point-to-point switching elements includes one or more conjugation elements between one or more first deflection elements and one or more second deflection elements.

42. The optical switch as claimed in claim 41, wherein the conjugation elements of a deflection module are arranged in a small rod.

43. The optical switch as claimed in claim 41, wherein the first and second deflection elements are arranged as small rods.

44. The optical switch as claimed in claim 41, wherein one or more deflection elements of at least one deflection module of the point-to-point switching elements are combined with one or more deflection elements of the selection means.

45. The optical switch as claimed in claim 25, having 2N input channels and N output channels, wherein the selection means includes a selection module of N selection elements mounted in parallel, and the connection means includes a point-to-point switch, the selection module and the point-to-point switch including small rods of N lenses and small rods of N mirrors configured to assume at least two angular positions.

46. The optical switch as claimed in claim 25, having 2N input channels and 2N output channels, wherein the selection means includes an input selection module, an output selection module, and switching means of a point-to-point switch located between the input selection module and the output selection module, the selection modules including N selection elements mounted in parallel, the selection modules and the point-to-point switch including small rods of N lenses and small rods of N mirrors configured to assume at least two angular positions.

47. An optical switch having 2N input channels and N output channels, comprising:
selection means formed by a selection module of N selection elements mounted in parallel;
connection means formed by a point-to-point switch, the selection module and the point-to-point switch including small rods of N lenses and small rods of N mirrors configured to assume at least two angular positions.

48. An optical switch having 2N input channels and 2N output channels, comprising:
selection means formed by an input selection module, an output selection module, and switching means formed by a point-to-point switch located between the input selection module and the output selection module,
the input and output selection modules including N selection elements mounted in parallel, the input and output selection modules and the point-to-point switch including small rods of N lenses and small rods of N mirrors configured to assume at least two angular positions.
